(19) United States
(12) Patent Application Publication
(10) Pub. No.: US 2007/0041552 A1
(43) Pub. Date: Feb. 22, 2007

(54) Driver-attentive notification system

(76) Inventor: Jonathan D. Moscato, Alden, NY (US)

Correspondence Address: Jonathan D. Moscato, 3460 Wende Rd, Alden, NY, 14004, US

(21) Appl. No.: 11/451,638

(22) Filed: Jun. 13, 2006

Related U.S. Application Data
(60) Provisional application No. 60/690,114, filed on Jun. 13, 2005.
(60) Provisional application No. 60/732,738, filed on Nov. 2, 2005.
(60) Provisional application No. 60/750,088, filed on Dec. 13, 2005.
(60) Provisional application No. 60/775,141, filed on Feb. 20, 2006.

(51) Int. Cl. H04M 3/42

(52) U.S. Cl. 379/214.01

(57) ABSTRACT

The Driver-Attentive Notification System was invented to allow a driver who is conversing on a cell phone to purposefully inform a remote caller to temporarily reduce her conversation intensity level when faced with an attentive condition. The device works when the driver presses an activation switch, which causes the notification system change to an activated state and then sends a notification message to a remote caller to inform her to temporarily reduce her conversation intensity level. A resume message is also sent to the remote caller when the driver changes the notification system back to the deactivated state. This message is sent to inform the remote caller that it is ok to resume her normal conversation intensity level.

### CROSS-REFERENCE TO RELATED APPLICATIONS

This application claims the benefit of provisional patent application for Ser. No. 60/690,114 filed on 2005 Jun. 13 by the present inventor; Ser No. 60/732,738 filed on 2005 Nov. 2 by the present inventor; Ser No. 60/750,088 filed on 2005 Dec. 13 by the present inventor; and Ser No. 60/775,141 filed on 2006 Feb. 20 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to telephone notification devices and more particularly to a telematic notification system to inform a remote caller to reduce her conversation intensity level so as to allow the mobile phone user to concentrate on an attentive condition.

2. Prior Art

Driving while distracted has resulted in a significant percentage of automobile accidents. A source of distraction while driving occurs when a remote caller continues the same conversation intensity level after the driver has identified a condition that warrants increased attention. Currently, the remote caller can not quickly ascertain sufficient knowledge of the driver's attentive state and will often misinterpret the driver's unresponsive behavior when he is in an attentive state as an invitation to maintain the same conversation intensity level. Thus, it is desirable to supply feedback to the remote caller which pertains to the driver being in an attentive state, in order to reduce the remote caller's conversation intensity level thereby avoiding driver distraction during attentive conditions, thus improving driving safety.

The current focus of research to improve driver safety is through the use of various types of workload managers. Workload managers are devices that continuously monitor driving, road and driver conditions by using sensors. The sensor output values are then compared to stored threshold values within a central processor to determine if an unsafe condition has been measured. For instance, accelerometers can be used to measure hard breaking or swerving of the vehicle. Eye tracking cameras can be used to measure if the driver's eyes remain off the road for too long a period of time. Road sensors can be used to measure traffic congestion.

When a workload manager's central processor detects sensor threshold exceedance, it then performs some function to reduce driver distraction. For example, a function to reduce driver distraction may include suspending a telephone conversation until some time after a sensor value has fallen below a predefined threshold value. The ‘workload manager concept’ suggests that it is unsafe for a driver to communicate on a cell phone during the times in which a sensor has exceeded its predefined threshold value. For example, the theory would suggest that it is unsafe to communicate while driving when performing a maneuver, or while the driver's eyes are not on the road.

The study (Punitha Manalavan, Asad Samar, Mike Schneider, Sara Kiesler, Dan Siewiorek, In-Car Cell Phone Use: Mitigating Risk By Signaling Remote Callers, Proceedings of the SIGCHI Conference on Human Factors In Computing Systems, Apr. 20-25, 2002, Minneapolis, Minn., USA) [1] has shown a method for reducing the hazard of driving and conversing on a cell phone while performing a difficult driving maneuver. The method consists of signaling a remote caller based upon an estimate of driving risk using a context aware cell phone and real time localized traffic data to implement a signaling system. The problem with this method is that it relies on a context aware cell phone (work load manager) to automatically determine if an ongoing driving situation meets or exceeds predetermined criteria for activation. Relying on a workload manager for activation can not ensure a driver that a conversation will be interrupted after a he first identifies an attentive condition and needs to concentrate.

The study (Mike Schneider, Sara Kiesler, Calling While Driving: Effects Of Providing Remote Traffic Context, Proceedings of the SIGCHI Conference on Human Factors In Computing Systems, Apr. 2-07, 2005, Portland, Oreg., USA) [2] shows by experiment that remote callers will moderate their conversation intensity level at appropriate times if supplied with real time information about the driver's traffic using (1) live streaming video or (2) contextual information via simulated traffic noises. This research further supports a supposition that “shared mutual knowledge of the traffic situation would improve safety because it would moderate the caller's behavior”. The research finds that “an obstacle to usage in both scenarios would be false positives” because either the remote caller would have to interpret remote video or a workload manager would have to decide if a traffic noise should be transmitted. The problem with the device disclosed within this paper is that it relies on a workload manager to determine when traffic noises should be sent.

U.S. Pat. No. 6,577,859 to Zahavi (2003) discloses using a plethora of buttons located on a cell phone to send messages which are “responsive to speech uttered by the remote caller”. The device is intended for use in settings in which it is inappropriate for the cell phone user to speak. A user therefore uses the buttons, which have pre-recorded messages associated with them, to respond to the speech uttered by a remote caller. For example, the cell phone user may respond “Yes” or “No” to questions asked by the remote caller using the buttons. Zahavi's disclosed device does not send messages that inform but instead it sends messages responsive to speech uttered by a remote caller.

U.S. Pat. No. 6,188,315 to Herbert (2001) discloses using remote sensors to measure driving conditions such as hard braking and sharp turning. The sensors are in communication with the device, which compares the sensor values to stored threshold values. When the device detects sensor values exceeding a stored threshold value, it activates and suppresses phone communication. Some time after the device detects that all the sensor values have fallen below their respective threshold values, the device acts to restore phone communication. During device activation it may optionally send a message to the remote caller which has the means to inform the remote caller that the connection is interrupted and the call is on hold. Herbert disclosure uses a workload manager whose activation means is complex because it requires real time data acquisition, stored calibration and threshold data. Herbert's automatic means of activation is not effective because it does not allow for activation when a driver needs to concentrate during times in which there is no sensor threshold exceedance. These times include the (1) moments before making a maneuver, in which decisions have to be made; e.g. at a stop sign, while waiting for a chance to pull into traffic, (2) maneuvers which do not exceed sensor thresholds; e.g. changing lanes and (3) situations in which concentration is needed and no maneuver is performed; e.g. traveling through an intersection while at constant speed. Additionally, relying on driving condition sensors to exceed predetermined threshold values may be problematic. This is because the device couples driving conditions to a function of the cell phone. This coupling may negatively affect the resulting driving conditions (which the driver controls) if he is influenced by the device's activation. For example, he may brake extra hard in order to purposely activate the device.

U.S. Pat. No. 6,731,925 to Naboulsi (2004) discloses using two hand sensing sensors located on a vehicle's steering wheel at the 10 and 2 o'clock positions to deactivate the device, thereby allowing for normal cell phone communication. The device requires that both sensors detect the presence of a hand in order for the device to be deactivated. During activation, phone communication is suppressed. Also, the device allows activation (phone suppression) only when the car is moving. Because Naboulsi's disclosed device suppresses the phone during activation without supplying a message to the remote caller, it is likely that the remote caller may become confused and either continue speaking or think the connection is lost and hang up. Additionally, interruption likely occurs more often with this device because drivers frequently need to remove their hands from the steering wheel to perform routine driving tasks. Naboulsi's device does not allow for activation while the vehicle is stationary. It is important for the driver to concentrate when the vehicle is stationary because he may be in a situation, such as stopped at an intersection, waiting to pull into traffic.

Requiring a driver to maintain both hands on the steering wheel sensors and requiring one hand to be removed in order to control activation may be problematic because the device couples the driver's steering wheel hand position with a function of a cell phone. This coupling may negatively effect the steering of the car if the driver is influenced by the device's activation. For example, the driver could continue holding onto the steering wheel with both hands when he should release his hands in order to turn properly, thereby avoiding activation. Additionally, the driver could release one hand from the steering wheel in situations where it should remain, thereby initiating activation. The two examples given within Naboulsi's disclosure show the device being used to protect a driver from distraction by ensuring that he does not use either hand to answer an incoming call or make an outgoing call while his vehicle is moving.

Japanese patent laid-open number HEI 10-304464 to Tatsuya (1997) and French patent application FR2005/050323 to Couturier (2005) both disclose a device which allows a cell phone using driver to purposefully place a call on hold (muting the call's send and receive voices) and send an audio message to the remote caller which contains a reason for the hold state. Couturier's device sends a ‘hold message’ signal through a bus to a ‘circuit of standby’. Couturier's ‘circuit of standby’ then mutes the send and receive voices of the call to place the call on hold. There are problems associated with a driver using a hold device to reduce distraction during attentive conditions. When muting a call's send and receive voices during an attentive condition the remote caller may:
become curious about what the driver is doing;
become impatient and wonder how long the suspension will last;
wonder if the phone connection is still ok;
become distracted by things outside the conversation and lose interest in continuing the conversation;
feel that the driver has an unfair conversational advantage because he has the power to mute the remote caller at any time;
need to hang up due to other obligations outside of the conversation, and has no way to communicate this to the driver.
   Due to these problems associated with using the hold function device during attentive conditions, it is likely that a driver will feel reluctant to use this device when confronted with such conditions. Reluctance to activate a hold device when faced with an attentive condition is a problem, because the driver is then forced to cognitively consider the cost of activating the hold device, instead of immediately performing the motor task of activating the device and then cognitively focusing on the attentive condition.

U.S. Pat. No. 5,099,508 to Inaba discloses a 2 state hold function. Inaba discusses how it has been considered to solve the problems associated with the hold function by allowing remote caller voice to be sent to the driver while the telephone is still in the hold state while the driver's voice is still muted. Inaba states that enabling the remote caller to talk while the call is on hold is undesirable because the driver will hear the remote caller's voice, which is noisy. In this case, the driver can do nothing to silence the remote caller when the remote caller starts talking during a hold state, due to the driver's voice being muted.

### BACKGROUND OF THE INVENTION—OBJECTS AND ADVANTAGES

It is therefore an object of the present invention to provide a novel notification system devoid of the above noted disadvantages of the prior-art.

It is another object of the present invention to create a notification system that is capable of reducing the remote caller's conversation intensity level independent of road and vehicle measurements.

It also is an object of the present invention to create a notification system that informs a remote caller to reduce her conversation intensity level in the time immediately after a driver mentally identifies an attentive condition to allow the driver sufficient time to evaluate the condition while undisturbed, before taking corrective action.

It is a further object of the present invention to create a notification system devoid of instances of false positives.

It is still a further object of the present invention to create a notification system with a method of purposeful activation that is devoid of coupling to vehicle driving controls, in order to eliminate the possibility of causing a positive feedback condition.

It is yet another object of the present invention to create a notification system that allows limited communication during an attentive condition, in order to keep a remote caller continually informed.

It is an additional object of the present invention to create a notification system that reduces potential reluctance a driver may have to purposefully interrupt a remote caller in mid sentence.

It is still another object of the present invention to create a notification system that informs a remote caller to reduce her conversation intensity level when the driver is confronted with an attentive condition.

Yet another object of the present invention is to create a notification system that continually reminds a remote caller to reduce her conversation intensity level for the duration of an attentive condition.

Another still further object of the present invention is to create a notification system that notifies a remote caller to resume normal conversation intensity level when an attentive condition has passed.

Still yet another object of the present invention is to create a notification system that allows a driver to quickly and easily reduce the remote caller's conversation intensity level.

Another further object of the present invention is to create a notification system that is capable of informing a remote caller to reduce her conversation intensity level when a driver is dealing with an attentive condition that is devoid of any measurable change in road or vehicle conditions.

It is another object of the present invention to create a notification system that does not distract or annoy a driver during an attentive condition.

It is still another object of the present invention to create a notification system that is useful to people employed in any type of activity while using a telephone, in which there is a need to reduce the conversation intensity level of a remote caller.

Another yet object of the present invention is to create a notification system that automatically reduces the audio volume of the remote caller's voice reaching the driver's ear(s) if the remote caller does not comply with a request to reduce her conversation intensity level during an attentive condition.

It is another object of the present invention to create a notification system that does not annoy a remote caller during an attentive condition.

Yet another object of the present invention is to create a notification system that is capable stopping a remote caller's speech in mid-sentence without the remote caller becoming confused.

Still another object of the present invention is to create a notification system that is small enough to be contained within a cell phone.

These and additional objects of this invention are accomplished generally speaking by a novel notification system and method that enables a driver to concentrate when dealing with an attentive condition by reducing the conversation intensity level of the remote caller.

Further objects and advantages of this invention will become apparent from consideration of the drawings and ensuing description.

### SUMMARY OF THE INVENTION

In one aspect of the driver-attentive notification system enables a driver using a cell phone who is faced with an attentive condition to purposefully activate the notification system in order to reduce the conversation intensity level of a remote caller during an attentive condition.

This patent is based upon the theory that the time in which a driver is most susceptible to distraction occurs in the period after he has mentally identified a situation termed ‘attentive condition.’ The term attentive condition is used herein as any situation encountered by a driver which requires cognitive processing. A driver will often have time to analyze and make decisions before initiating a corresponding action or driving maneuver, when confronted with an attentive condition. Situations requiring cognitive processing are managed by a theoretical psychological mechanism called the ‘central executive.’

The type of situation requiring management of the central executive include error correction or troubleshooting, situations in which responses are not well learned or contain novel sequences of action, danger or technical difficulty, overcoming of strong habitual response or resisting temptation, or any other type of situation where routine activation of behavior would not be sufficient for optimal performance [8]. More generally speaking, attentive conditions are novel situations handled outside the domain of some of our ‘automatic’ psychological processes that could be explained by the reproduction of learned schemas or set behaviors [7].

It is detrimental for a remote caller to distract a driver after he has first identified an attentive condition because the driver is highly susceptible to distraction. Attentive conditions are mentally identified by the driver and often times start before a maneuver is even made. Attentive conditions are thus difficult or impossible to identify using workload manager sensors.

According to Smith [4], the following sequential psychological stages called ‘choice reaction’ occur after an attentive condition is presented to a driver:
Stage 1: mentally identify the condition (perceptual);
Stage 2: analyze the situation (cognitive);
Stage 3: decide on the course of action (cognitive);
Stage 4: perform the chosen action (motor).

Examples of attentive conditions include, when a driver mentally identifies a situation (stage 1) in which he needs to perform the following:
determine if there is an open gap in traffic (stages 2 & 3), before pulling onto a highway (stage 4);
determine if his blind spot is clear, before changing lanes;
determine if the oncoming lane is free of head-on traffic, before passing a truck;
determine if a light will turn yellow, before traveling through an intersection;
determine if a street sign is the one he is looking for, before slowing down and making a turn.

The notification system sends a notification message to the remote caller that has the means to inform the remote caller to reduce her conversation intensity level and may also inform the remote caller that the driver is faced with an attentive condition. The conversation intensity level is used herein as the amount of cognitive load imposed upon the driver due to a remote caller's speech. The amount of cognitive load imposed upon the driver is a function of the remote caller's pausing duration, speech rate, complexity of subject matter, tone, duration between turns, pauses between turns, emotion of subject matter; volume, clarity of speech, or any other conversation or speech characteristic that imposes cognitive load upon the driver.

The notification message is preferably comprised of a first and second audio. When the notification system is activated the first audio is sent to the remote caller to inform her to reduce her conversation intensity level. The second audio is then sent to the remote caller to remind her to maintain a reduced conversation intensity level and is played until the notification system is deactivated. When deactivated, the notification system preferably sends a third audio to the remote caller informing her that it is OK to resume the normal conversation intensity level.

The term ‘driver’ is used herein as a person operating a cell phone. When the term ‘driver’ is used within the context of a person operating a motor vehicle, then the term is to be literally applied. The term ‘cell phone’ is used herein as any communication device that allows for two way voice communication.

### DRAWINGS—FIGURES

FIG. 1 illustrates the notification system and its components.

FIG. 2 illustrates the arrangement of the preferred embodiment with the control unit contained within a separate enclosure.

FIG. 3 illustrates the arrangement of the second embodiment with the control unit contained within the cell phone.

FIG. 4 illustrates the arrangement of the third embodiment with the control unit contained within the headset.

FIG. 5 illustrates the arrangement of the forth embodiment with the control unit contained within the cell phone and the activation switch located on the telephone face in such a way as to sense if the telephone is being held to the ear.

FIG. 6 illustrates the arrangement of the fifth embodiment with the control unit contained within the cell phone and the activation switch mounted to the outside of the telephone.

FIG. 7 illustrates a multi-switch arrangement of the sixth embodiment.

FIG. 8 illustrates the arrangement of the seventh embodiment with the control unit contained within the cell phone and activated by voice recognition.

FIG. 9 illustrates the state diagram of the preferred embodiment.

FIG. 10 illustrates an attentive driving scenario of a vehicle located at a stop sign.

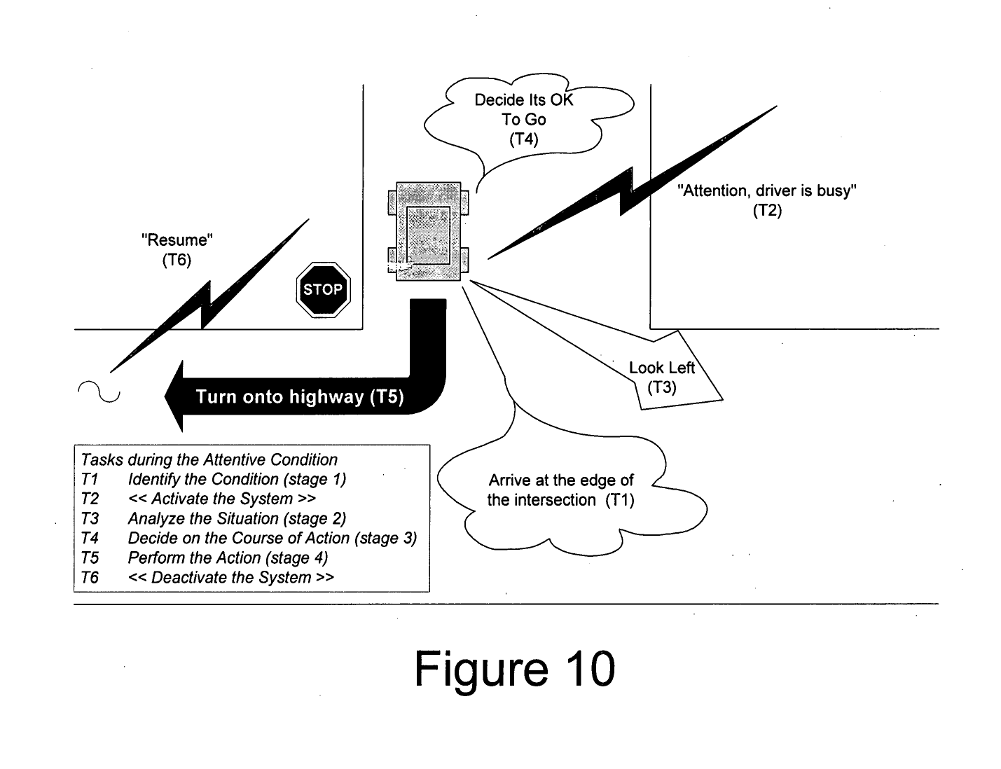

### DRAWINGS—REFERENCE NUMERALS

1a activation switch, actuated by a finger
1b activation switch, actuated by an ear
1c activation switch, actuated by voice recognition
1d heavy traffic activation switch
1e left hand turn activation switch
1f right hand turn activation switch
1g externally triggered activation switch
2 control unit
3a finger as actuation stimuli
3b ear as actuation stimuli
3c voice as actuation stimuli
4 driver
5 coupling between activation switch and digital input pin
6 microcontroller
6a digital input pin of microcontroller (activation switch detection means)
7 first terminal of control unit 2
8 message generated by audio chip
9 remote caller
10 cell phone
11 remote telephone
12 audio input of cell phone & communication signal means input
13 coupling between cell phone audio input 12 and first terminal 7
14 telephonic connection between cell phone 10 and remote telephone 11
15 audio output of cell phone 10
16 second terminal of control unit 2
17 third terminal of control unit 2
18 DSD2560 Sound Chip (message sending means)
19 coupling between cell phone audio output 15 and second terminal 16
20 suppression switch
21 coupling between suppression switch 20 and volume reducing circuit 22
22 volume reducing circuit (volume reducing means)
23 fourth terminal of control unit 2
24 coupling between fourth terminal 23 and first terminal 7
25 microphone of headset 29
26 coupling between microphone 25 and fourth terminal 23
27 speaker of headset 29
28 coupling between speaker 27 and third terminal 17
29 headset
30 enclosure
31 steering wheel column
32 audio output of remote telephone 11 & communication signal means output
33 red LED
34 green LED
35 reset switch
36 voice recognition module
37 executing computer program within microcontroller 6 (logic means)
38 cell phone 10 and remote telephone 11 telephonically connected
(communication signal means)
39 speaker of speakerphone
40 microphone of speakerphone
41 microphone of cell phone 10
42 speaker of cell phone 10

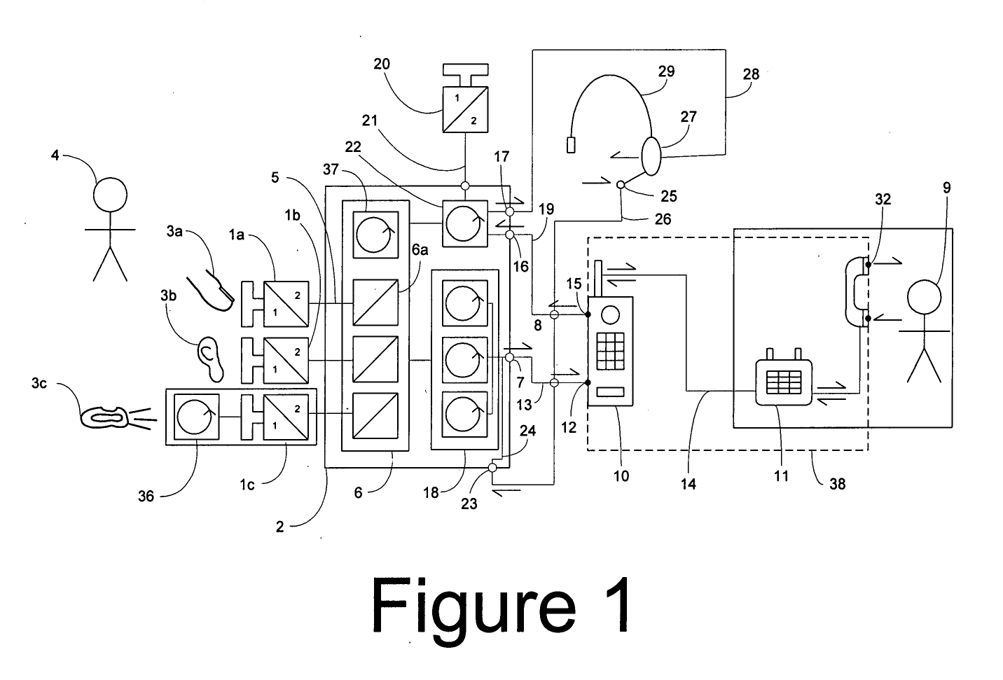

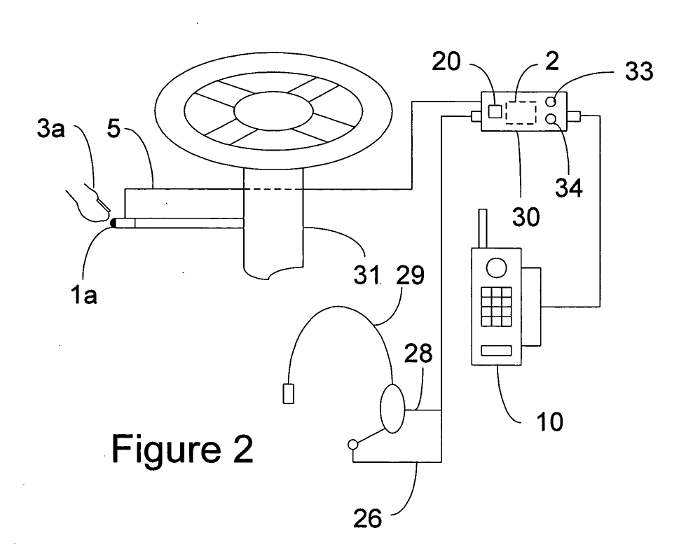

### DETAILED DESCRIPTION—FIGS. 1 AND 2—THE PREFERRED EMBODIMENT

As shown in FIG. 1-2, the preferred embodiment of the notification system is comprised of activation switch 1a, control unit 2 encased within enclosure 30, cell phone 10 and remote telephone 11 which are in telephonic communication, and headset 29. Driver 4 operates activation switch 1a while using cell phone 10 and remote caller 9 operates remote telephone 11. Control unit 2 contains preprogrammed microcontroller 6 which contains digital input channels (‘detection means’) and executing software program 37. Control unit 2 also contains preprogrammed DSD2560 sound chip 18.

Activation switch 1a is turned ON by pressing it with finger 3a. Activation switch 1a is mounted to shaft 32 extending radially from automobile steering column 31. Activation switch 1a is a stay switch that remains in its current state after removal of finger 3a. Activation switch 1a is connected to control unit 2 via electrical wire 5a.

For this embodiment, control unit 2 is packaged within enclosure 30. Cell phone 10 is coupled to control unit 2 via a first audio cord consisting of input line 13 which connects first terminal 7 on the control unit to audio input 12 on the cell phone and output line 19 which connects second terminal 16 on the control unit and audio output 15 on the cell phone.

Headset 29 is coupled to control unit 2 via a second audio cord consisting of input line 28 which connects third terminal 17 on the control unit to speaker 27 on the headset and output line 26 which connects forth terminal 23 on the control unit to microphone 25 on the headset.

Within the control unit, forth terminal 23 and first terminal 7 are both connected to the audio output of sound chip 18. This connection allows an audio signal from both microphone 25 and chip 18 to be sent simultaneously to audio input 12 of the cell phone, thereby allowing driver 4 to speak while activation switch 1a is ON.

Computer program 37 executing within microcontroller 6 is designed to continually watch digital input channel 6a of microcontroller 6 for a voltage signal emanating from activation switch 1a. When computer program 37 detects a change from 5 volts to 0 volts, it runs a section of code (running this section of code is equivalent to the notification system being in its activated state) that sends a first serial command to chip 18, which in turn sends a first stored audio stating “Attention, please pause” to audio input 12 of cell phone 10. Computer program 37 pauses for 2.5 seconds duration after sending the first serial command to wait for the first stored audio to complete.

If activation switch 1a is still ON (the notification system is still in the activated state) after playing the first audio then computer program 37 next sends a second serial command to chip 18. When chip 18 receives the second serial command it then sends a second stored audio consisting of a high pitched beep. Computer program 37 pauses for 3 second duration after sending the second serial command to allow a silent time between beeps. The second serial command and the pause are next repeated until computer program 37 detects that activation switch 1a has been turned OFF, as reflected the voltage signal changing from 5 volts to 0 volts.

When activation switch 1a has been turned OFF, computer program 37 interrupts its 3 second pause and sends a third serial command to chip 18. When chip 18 receives the third serial command it then sends a third stored audio stating “Resume”. Computer program 37 pauses for 1 second duration after sending the third serial command to allow the third audio to complete (when finished, the system is then in its deactivated).

Red LED 33 and green LED 34 are coupled to control unit 2 and controlled by digital output pins of microcontroller 6. The LED's are mounted to the exterior of enclosure 30 so as to be visible to driver 4. When the notification system is in the activated state, control unit 2 turns red LED 33 to ON and green LED 34 to OFF. When the notification system is in the deactivated state then control unit 2 turns green LED 34 to ON and red LED 33 to OFF.

Suppression switch 20 is a pushbutton stay switch that is installed within enclosure 30, accessible to driver 4. Switch 20 is coupled to volume reducing circuit 22. Volume reducing circuit 22 is wired so that if the notification system is activated and suppression switch 20 supplies 5 volts, then the notification system's sub-state is considered to be in a suppressed state, otherwise the sub-state is considered to be in a normal state.

While the notification system is in the suppressed state, the 5 volt output voltage of suppression switch 20 switches two relays contained within volume reducing circuit 22 so that audio signal passes through a potentiometer, thereby reducing audio signal volume. When the notification system's sub-state is normal or when the notification system's state is deactivated, then the signal is routed around the potentiometer so that the audio signal is not reduced in volume.

The volume reduction feature can be used when driver 4 elects to decrease audio volume reaching speaker 27 if remote caller 9 fails to reduce her conversational level during the time when the notification system is in the suppressed state.

### Additional Options of the Preferred Embodiment—FIGS. 1 and 2

Couplings 5, 13, 19, 21, 26 and 28 are preferably comprised of wire and alternately comprised of radio frequency, infrared, sound or any other transmitting media. The signals handled by the couplings are preferably comprised of constant amplitude and alternately comprised of analog or binary signals. If comprised of analog or binary and if sent via radio frequency or infrared then they are preferably encrypted. If encryption is used, control unit 2 must contain a means to decrypt the signals. If radio frequency is used, then the preferable mode of communication is Bluetooth.

Activation switch 1a's actuation stimuli is preferably force generated by a finger of driver 4 and alternately may be generated by hand, foot, face, ear, voice, sound, eye, heat or gesture. Activation switch 1a mounting locations is preferably a shaft radially projecting from steering column 31 and alternately located on the steering wheel rim, steering wheel web, dashboard, floor, shifter, cell phone 10, enclosure 30, or any other location accessible to driver 4.

Activation switch 1a preferably consists of a push button stay switch and alternately may consist of a toggle, rocker, slide, proximity or optical switch. Activation switch 1a is preferably a stay switch which maintains its state after switching alternately the switch may consist of a return switch which changes back to its original state after it is actuated.

Preferably the notification system uses headset 29 and alternately a speakerphone may be used comprising speaker 27 and microphone 25. The speakerphone may be a self contained module or be integrated within the vehicle.

Preferably activation switch 1a outputs a constant signal and alternately provides a short duration signal. If a short duration signal is provided than computer program 37 can be used to keep track of the sate of activation switch 1a.

### Message Composition of the Preferred Embodiment

A notification message is preferably composed of a first audio and second audio. A resume message is composed of a third audio. The first audio is preferably an introduction that is sent in full, a single time when activation switch 1a is changed to ON. The first audio preferably states “Attention, please pause” and alternately “Attention, Please Reduce Conversation intensity level”, “Driver is Busy” or a beeping sound tot inform the remote caller to reduce her conversation intensity level.

The second audio is preferably used as a ‘filler’ to continually remind remote caller 9 to maintain a reduced conversation intensity level. The second audio preferably does not have a distinct beginning or ending. The second audio is sent after the first audio has completed, if activation switch 1a is still ON, and continues until activation switch 1a is turned OFF. The second audio preferably consists of a high pitched beep sound repeated once every three seconds and alternately consists of a clicking sound, chirping, buzzing, music, radio, traffic report, static, car state, traffic state, traffic noise or the statement “Hold” repeated. Alternately, the second audio may also be sent to driver 4 as a reminder that activation switch 1a is ON.

The third audio is sent after activation switch 1a has been changed to OFF and is used to inform remote caller 9 that conversation may resume. The audio preferably states “Resume” and alternately states “Conversation may continue” or plays a beeping sound.

Different combinations of audios may be used. The audio combination is preferably first-second-third and alternately consists of first-third, first-second, second-third, first or second. These combinations may be used as long as the overall message has the means to inform remote caller 9 to reduce her conversation intensity level.

Preferably the first-second-third audios are sent every time activation switch 1a is turned ON then OFF during a phone call. Alternatively, the first-second-third audio combination could be sent the first time that the notification system is activated and then deactivated, and all subsequent notification system state changes would result in only the second audio being sent, for a given phone call.

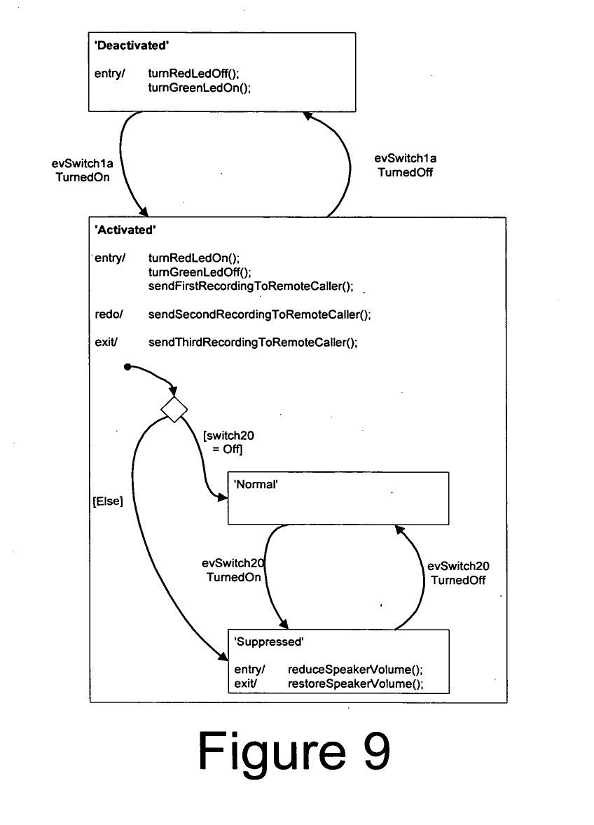

### Operation of the Preferred Embodiment—FIG. 9

FIG. 9 is a state diagram of the preferred embodiment. If the notification system starts from the ‘deactivated’ state with activation switch 1a OFF, then red LED 33 is OFF and green LED 34 is ON. If activation switch 1a is then turned ON, then the notification system's state is transitioned to ‘activated’.

When the activated state is entered, red LED 33 is turned ON, the green LED 34 is turned OFF and a first audio is sent to remote caller 9. In addition, if switch 20 is ON during this transition then the sub-state entered is ‘suppressed’ and the speaker volume is reduced in volume. If at any time while in the activated state, switch 20 is turned OFF then the volume of speaker 27 will be restored and the sub-state will transition to ‘normal’.

After first audio has finished playing, the second audio is repeated to remote caller 9 until activation switch 1a is turned OFF. When activation switch 1a turns OFF, the second audio is immediately stopped and third audio is then played to remote caller 9. When this audio is finished, the notification system's state is transitioned back to ‘deactivated’ and red LED 33 is turned OFF and green LED 34 is turned ON.

### Theory of Operation of the Preferred Embodiment

It is theorized that when a driver who is talking on a cell phone and encounters an attentive condition, cognitive stages 2 & 3 will likely be disrupted by the remote caller's conversation. By reducing the remote caller's conversation intensity level after the driver mentally identifies the attentive condition (after stage 1), the driver is then free to perform cognitive stages 2 & 3 while undisturbed.

It is also theorized that a driver conversing on a cell phone, who initially identifies an attentive condition (stage 1), can not verbally request that the remote caller reduce her conversation intensity level while at the same time start to mentally process the attentive condition (stages 2 or 3). The two tasks (verbal request, or stage 2 or 3) are both cognitive and the psychological mechanism called the ‘central executive’ can only coordinate the mental processing of a single cognitive task at a time.

It is theorized that a pre-recorded audio request would likely be more effective at quieting a remote caller than having a driver verbally request a reduction in conversation intensity level because (1) an audio source external to the conversation would likely queue a remote caller to the request, (2) a remote caller would quickly recognize the message and likely know what to do, if she had heard it before and (3) the driver's request would likely consist of varying words and voice inflections, possibly making it more difficult to distinguish from other words spoken during the course of a conversation.

It is theorized that if the driver does not hear an audio message from the notification system in the time immediately after he activates the system, while at the same time the remote caller is quieted, then the driver will likely associate the motor task of actuating the activation switch with the resulting silence of the remote caller. The driver's association of a reduced conversation intensity level with the motor task will likely reduce the driver's hesitation to interrupt the remote caller in mid-sentence because the interruption is nonverbal and occurs after the switch is actuated. Using the device to solve this telephone distraction, the driver simply presses a switch which temporarily, but immediately interrupts the conversation with the remote caller.

The study by Manalavan [1] shows by experiment that (1) a remote caller will reduce her conversation when signaled to do so, and (2) the performance of a driver who is talking on a cell phone will improve if the remote caller reduces her conversation during critical driving periods. This research has significant implications with respect to improving driving safety while using a cell phone. It demonstrates that a remote caller can be quieted when sent a message, and if quieted during critical periods, then driver safety will drastically improve.

According to Manalavan [1], when a remote caller stops talking during critical driving situations “accident rates while talking returned to the same level as driving with no phone call”. Manalavan's study suggests that driving and talking on the phone during non-critical situations (devoid of attentive conditions) is as safe as driving with no phone call.

A driver approaching a congested intersection would be safer if he temporarily stopped his conversation on a cell phone. According to the study by Trbovich [5], “Driving through intersections is one of the most complex conditions drivers encounter because many complex perceptions, decisions and maneuvers are required to successfully negotiate intersections” and “drivers must be aware of traffic signal changes, pedestrians and on-coming traffic”. Trbovich determined that “when driving and performing the demanding cognitive task (using a cell phone), drivers made significantly fewer glances to the traffic lights compared to driving without the task”, thereby jeopardizing driver safety. Trbovich's study supports the supposition that the Driver-Attentive Notification System can improve driver safety. In this situation, the device quickly allows the driver who is approaching the potentially critical intersection to decisively disengage from his cell phone conversation.

A driver's purposeful activation of the notification system's switch does not pose a significant distraction when dealing with an attentive condition because, according to Schneider [2] “people can far more easily divide attention between motor and cognitive tasks”. For example, actuating the activation switch and simultaneously cognitively processing the attentive condition. Additionally, actuating a switch can be done much faster than making a verbal request.

A driver can't stop talking in order to make a remote caller stop talking because, according to Manalavan [1], when the driver pauses, the remote caller “keeps talking when there is silence on the line”. A remote caller will likely stop talking if a message is sent to her because, according to Manalavan [1], signaling the remote caller reduces the caller's words and conversation significantly”.

According to Strayer [6], in-vehicle conversations are modulated when a passenger sees an attentive condition at the same time as the driver. In the same way, the notification system supplies feedback to a remote caller in order to modulate her conversation when the driver first identifies an attentive condition.

A thorough review of the published research regarding distracted driving was conducted for this project and it was found that the vast majority of testing has not distinguished between ‘attentive conditions’ and ‘reactive conditions’. Again, the term ‘attentive condition’ is defined in this paper as any situation mentally identified by a driver (stage 1) which requires analysis (stage 2) and decision making (stage 3) before a driver should initiate a corresponding action or driving maneuver (stage 4). The term ‘reactive condition’ is defined in this paper as any situation mentally identified by a driver (stage 1) which requires immediate intervention (stage 4); for example, when a driver perceives a deer leaping directly into his path (stage 1) as he is driving down the road will immediately slam on his brakes (stage 4) with no hesitation. Reactive conditions can be thought of as preprogrammed responses, in which no cognitive choice is made (no stage 2 or 3) before action is taken.

It is important to understand the differences between attentive and reactive conditions. The notification system primarily protects against attentive conditions. Furthermore, it is theorized that it is not as important to protect a driver from distraction during reactive conditions because this type of condition usually does not require analysis and decision making before the driver initiates action; for example, no cognitive processing is required before stopping on the brakes after a driver sees a deer leap in front of his vehicle while he is driving.

An attentive condition is initiated by a driver's mental identification of a situation. The condition will then involve cognitive processing, before the driver performs an action or maneuver. Thus, attentive conditions can not be measured by a workload manager's sensors due to the condition being initiated before a driving maneuver is performed.

The driver's purposeful activation of the notification system after first identifying an attentive condition is similar to when a driver first mentally identifies the approach of a turn in which he purposefully activates his turn signal. To the author's knowledge, drivers who are conversing on a cell phone have no difficulty with the motor task of activating a turn signal before making a turn.

The notification system has an ability to send messages to a remote caller during an ongoing conversation (without muting the driver's and remote caller's voices) and then relies on the remote caller to voluntarily reduce her conversation intensity level. This mode of operation is similar to the mode of operation of a turn signal. When a turn signal is activated, a sound is transmitted within the vehicle compartment and acts to inform a passenger to voluntarily reduce her conversation level.

Thus, the reader will see that purposefully sending a message to a remote caller using the notification system can be used to quickly and easily reduce distraction to a driver who is using a cell phone while dealing with an attentive condition. The notification system reduces distraction in situations devoid of measurable changes in road, vehicle or driver conditions. The invention works without needing to collect and analyze driving or vehicle information. The invention does not create situations of false positives or positive feedback and reduces reluctance a driver may have to abruptly interrupt a remote caller in mid-sentence.

While I believe these theories of operation to be true, I do not wish to be bound by them.

### Driving Scenario Using the Preferred Embodiment

The following example (see FIG. 12) illustrates a driving scenario involving use of the Driver-Attentive Notification System to temporarily reduce conversation with the remote caller while a driver focuses on an attentive condition consisting of making a right hand turn onto a congested and dangerous highway.

Time T0—Before Identifying the Attentive Condition: The driver is conversing with the remote caller on a cell phone while driving down a road. The driver continues conversing with the remote caller after noticing a stop sign a distance ahead. The driver turns his turn signal. ON while slowing the vehicle to a full stop at the edge of the highway.

Time T1—Identify the Condition (stage 1): While fully stopped at the intersection, the driver realizes that he must concentrate his attention on determining when it will be safe to pull onto the highway.

Time T2—Activate the Notification System: The driver elects to activate the Driver-Attentive Notification System. The driver presses an activation switch located on a shaft protruding from the vehicle's steering wheel shaft. A first audio is automatically generated by the notification system stating “Attention, driver is busy.” The first audio message is transmitted by the driver's cell phone to the remote caller's telephone. The first audio is not sent to the driver's cell phone speaker. When the first audio is finished, a second audio consisting of a beep sound repeated every 3 seconds is sent to the remote caller. The second audio is sent to continually remind her to maintain a reduced conversation intensity level.

The driver knows that the notification system is in the activated state because the activation switch, which is a stay switch, is in the ON position, and a red LED is illuminated. The remote caller hears the first audio while she is in mid-sentence. The first audio gains the remote caller's attention very quickly because the voice on the first audio is not the driver's voice. The remote caller stops talking in mid-sentence to hear what the first audio says, and realizes that the driver is temporarily occupied (dealing with an attentive driving condition) and she should therefore reduce her conversation intensity level by temporarily pausing her speech. Half a second after the driver has activated the notification system, he suddenly hears silence because the remote caller has stopped talking.

Time T3—Analyze the Situation (stage 2): Half a second after the driver has activated the notification system, he is free to focus on the highway situation while remaining undisturbed by the remote caller's conversation. The driver looks out the driver side window to ensure that the highway lane is free from oncoming vehicles. The driver does this so that he can safely make a right hand turn onto the highway.

Time T4—Decide on the Course of Action (stage 3): The driver feels that he has sufficiently analyzed the highway situation and now determines that it is safe to perform the driving maneuver of making a right hand turn onto the highway and accelerating up to speed.

Time T5—Perform the Action (stage 4): The driver performs a maneuver of turning the wheel and moving his foot from the brake to the gas pedal. The driver pulls onto the highway and accelerates up to speed. As The driver is accelerating up to speed, The remote caller asks the driver “Are you still there?”. The driver Replies, “Yes, just a moment.” The driver is not distracted by the remote caller's question because it requires little cognition to answer (the remote caller's conversation intensity level has been significantly reduced) and the driver has already performed his cognitive tasks and is now performing a maneuver.

Time T6—Deactivate the Notification System: After the driver has accelerated up to speed on the highway he deactivates the notification system. The notification system sends a third audio to the remote caller stating “Resume.” The remote caller realizes that it is ok to resume her normal conversation level and restarts the conversation where she left off.

A driver needs adequate time to analyze and make decisions when faced with an attentive condition, and remote callers can cause distraction. This example shows that distraction from a remote caller can be reduced or eliminated with the Driver-Attentive Notification System, thus improving driver safety.

### Driving Scenario without Use of the Preferred Embodiment

The below listed example illustrates a driving scenario that does not involve use of a notification system to reduce the conversation intensity level of a remote caller while a driver attempts to focus on an attentive condition consisting of making a right hand turn onto a highway.

Time U0—The situation before identifying an attentive condition: The driver is conversing with the remote caller on a cell phone while driving down a road in a motor vehicle. The driver continues conversing with the remote caller after noticing a stop sign a distance ahead, the driver turns his turn signal ON while slowing the vehicle to a full stop at the edge of a highway that he must turn right on.

Time U1—Identify the Condition (stage 1): While fully stopped at the intersection, the driver knows that he must concentrate his attention to determine when it is safe to pull onto the highway.

Time U2—Driver Stops Talking: The driver stops talking in order to concentrate his attention on the task of determining if it is safe to pull onto the highway.

Time U3—Analyzes the Situation (stage 2): The driver looks out of his driver side window to ensure that the highway lane is free of oncoming traffic so that he can safely make a right hand turn onto the highway.

Time U4—Remote Caller Continues Talking: The remote caller misinterprets the driver's silence as an invitation to speak further because she thinks the driver is listening intently. In fact, the driver is attempting to analyze the current driving situation.

Time U5—Remote Caller Distracts Driver: The remote caller's continued talking has distracted the driver so that his mental concentration is diverted once again to the conversation with the remote caller. In the time in which the driver is distracted by the remote caller, he misses several opportunities to safely pull onto the highway.

Time U6—Limited Time to Act: A vehicle pulls behind the driver's vehicle and the other driver observes that the driver has missed several opportunities to pull onto the highway. The other driver becomes agitated and honks his horn.

Time U7—Driver is compelled to take Action: The driver hears the vehicle behind him honk. The driver feels compelled to perform the maneuver of pulling onto the highway. The driver becomes silent again as he breaks his mental focus away from the conversation to again focus on pulling onto the highway. During this time the remote caller continues talking.

Time U8—Driver rushes his Analysis and Decision Making (stages 2 & 3): The driver observes an opportunity to pull onto the highway, although it is not an ideal gap between vehicles. The driver realizes that he will have to act quickly and accelerate at a faster than normal rate in order to avoid slowing down the drivers that will be behind him.

Time U9—Perform the Action (stage 4): The driver performs the maneuver of turning the steering wheel and moving his foot from the brake to the gas pedal. The driver pulls onto the highway and floors it. The cars on the highway behind the driver have to slow down in order to avoid colliding with the driver.

This example shows that the driver is not protected from distraction while talking to a remote caller while attempting to deal with an attentive condition.

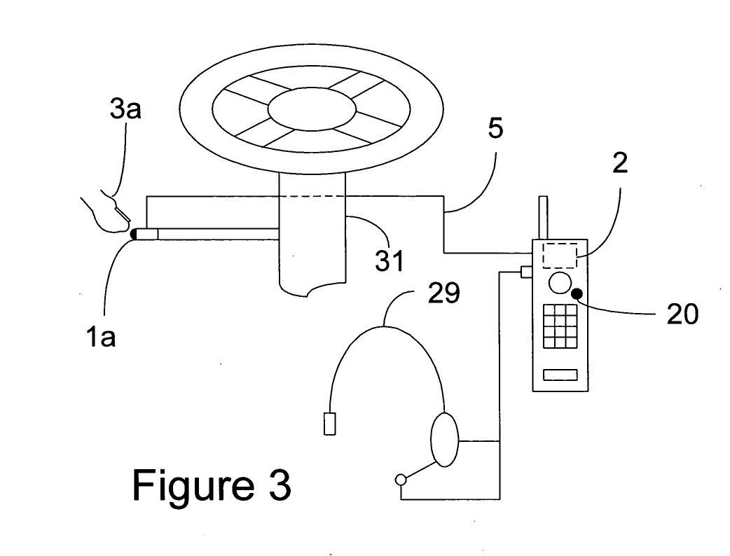

### Second Embodiment—FIG. 3

The second embodiment is the same as the preferred except that control unit 2 is encased within cell phone 10, suppression switch 20 is located on the external surface of cell phone 10, LED's are not used and a third audio is sent to speaker 27 while activation switch 1a is ON. The third audio consists of a high pitched beep and is started 3 seconds after activation and is repeated every 3 seconds while activation switch 1a remains ON to remind the driver that activation switch 1a is ON.

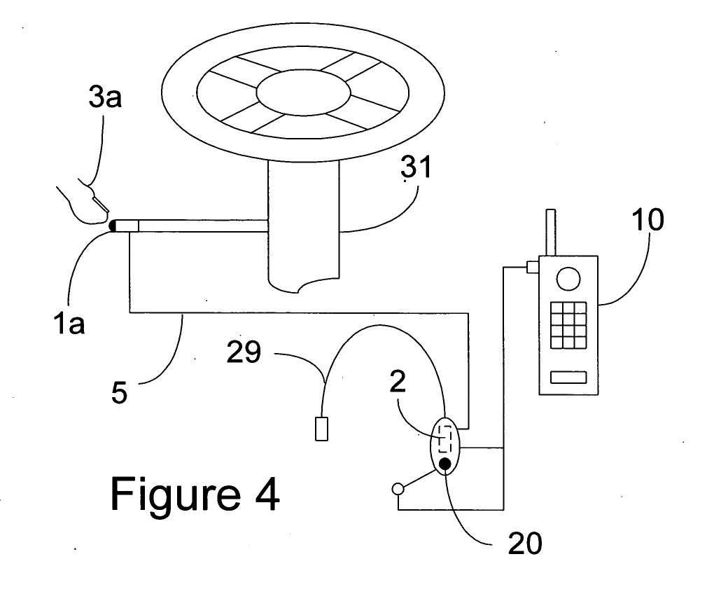

### Third Embodiment—FIG. 4

The third embodiment is the same as the second embodiment except control unit 2 is encased within headset 29 and suppression switch 20 is located on the external surface of headset 29.

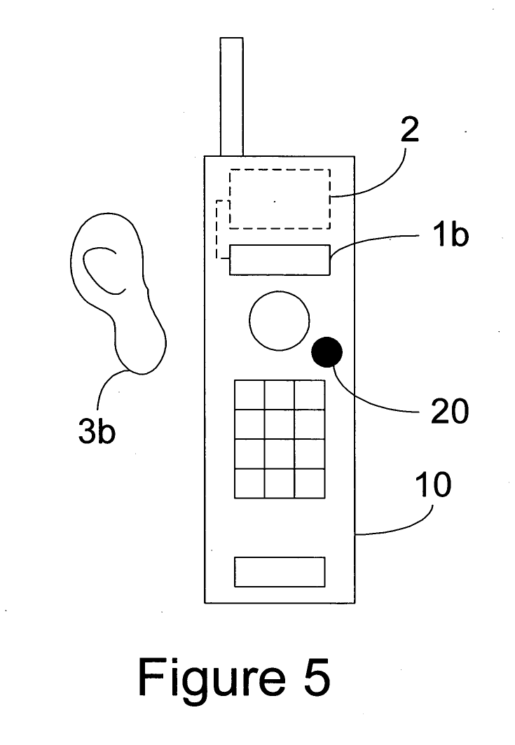

### Fourth Embodiment—FIG. 5

The forth embodiment is the same as the second embodiment except control unit 2 is encased within cell phone 10, suppression switch 20 is located on the external surface of cell phone 10, activation switch 1b is located on the face of cell phone 10 and headset 29 is not used, instead speaker 27 and microphone 25 are of cell phone 10. Switch 1b is a return switch that is normally ON and turned OFF only when held near the face of driver 4.

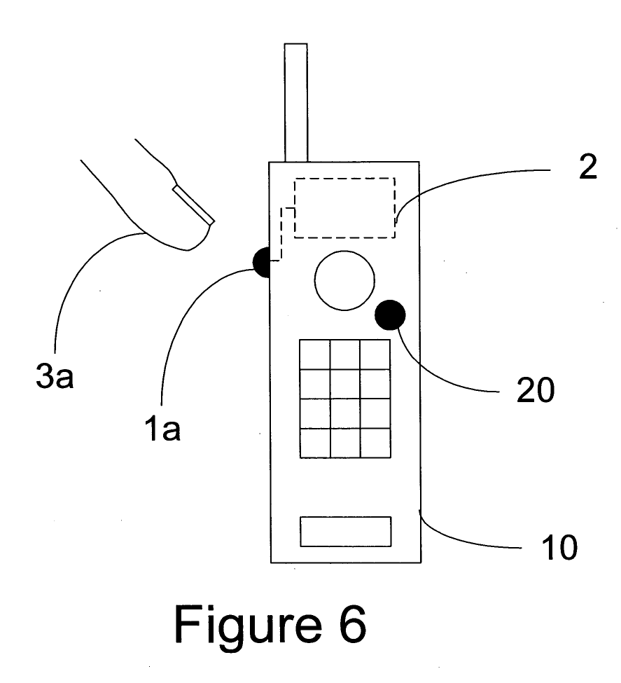

### Fifth Embodiment—FIG. 6

The fifth embodiment is the same as the second embodiment except control unit 2 is encased within cell phone 10, activation switch 1a and suppression switch 20 are both located on the external surface of cell phone 10 and headset 29 is not used, instead speaker 42 and microphone 41 are of cell phone 10.

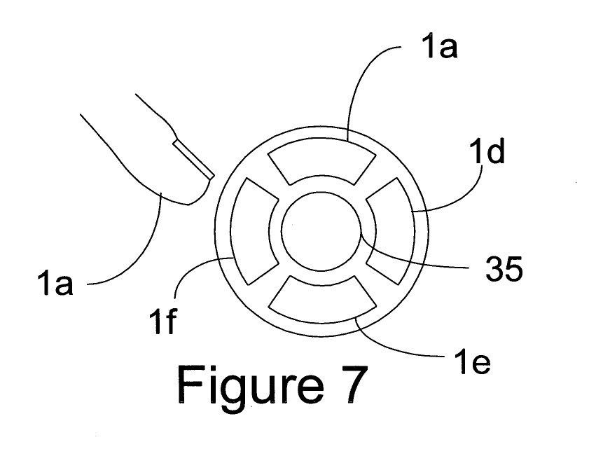

### Sixth Embodiment—FIG. 7

The sixth embodiment is the same as embodiments one, two and three except that it uses activation switches 1a, 1f, 1e and 1d and reset switch 35. The activation switches are each coupled to different digital input channels within microcontroller 6. Each of the digital input channels in turn sends a different serial control command to chip 18 so that the chip can generate an associated audio for each switch when turned ON. Each activation switch can be turned OFF by pressing it again or pressing reset switch 35. All switches generate the same third audio when they are turned OFF. For example, the audio for switch If states “Making Right Turn”; 1d states “Encountering Heavy Traffic”; 1e states “Making Left Hand Turn”; and 1a states “Attention, Please Hold”.

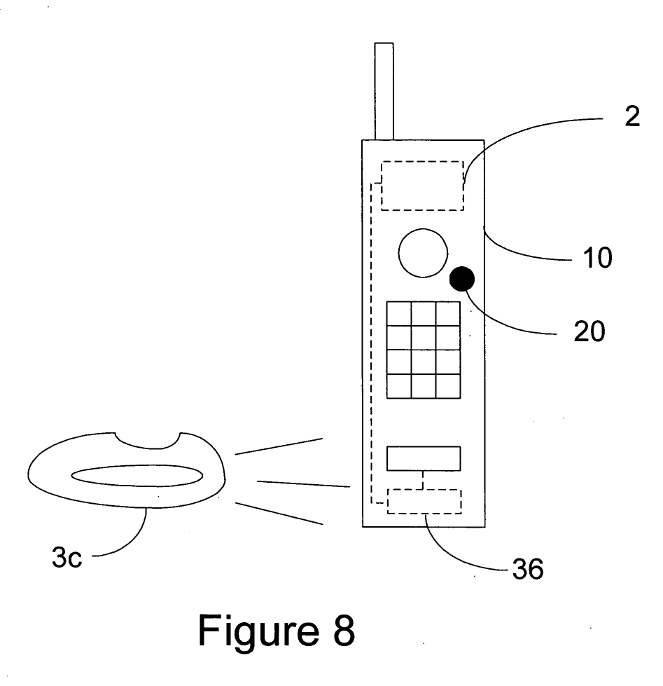

### Seventh Embodiment—FIG. 8

The seventh embodiment is the same as the sixth embodiment except that activation switches 1a, 1b, 1c and Id and reset switch 35 are turned ON/OFF by voice recognition module 36.

### Eighth Embodiment

The eighth embodiment is the same as the second embodiment except control unit 2 is located remotely within the cell phone's remote network.

### Ninth Embodiment

The ninth embodiment is the same as the seventh embodiment except control unit 2 and voice recognition module 36 are located remotely within the cell phone's remote network.

### Tenth Embodiment

The tenth embodiment is the same as the fourth and fifth embodiments except that when the notification system is activated, then the cell phone's speakerphone is turned ON, and when the notification system is deactivated the speakerphone is turned OFF. This embodiment allows a conversation to continue (at a reduced conversation intensity level) even if the driver removes the phone from his ear.

### Eleventh Embodiment

The eleventh embodiment is the same as all the above mentioned embodiments except that the notification system's externally triggered activation switch 1g may be activated by activation stimuli 44 which emanates from remote transmitter 43. Preferably, remote transmitter uses a radio frequency which activates the device and acts within a finite range of the notification system. Remote transmitter 43 may be placed at highway locations which require attentiveness by the driver. For example, transmitter 43 may be placed at busy intersections, before areas of road construction or any other highway location requiring driver attentiveness. Transmitter 43 may send specific activation signals to the notification system to then allow the notification system to notify the remote caller of the actual attentive condition. Remote transmitter 43 may also be located on emergency vehicles and used to inform remote callers to reduce their conversation intensity level as the emergency vehicle approaches. The remote transmitter may also be located on other vehicles and transmit information to the remote caller and/or the driver including when the other vehicle is breaking hard, turning, or poor road conditions are encountered by the other vehicle. Remote transmitter may also be used to transmit traffic information to the notification system, such as traffic congestion. In all of these uses within this embodiment, the notification message send to the remote caller may contain ‘specific statements’, and alternately ‘implicit statements’ or ‘indicative sounds’ to inform the remote caller to reduce her conversation level. The notification message may also inform the remote caller of the specific situation that the driver is confronted with. For example, the notification message for an approaching ambulance may say “Attention, emergency vehicle is approaching”.

### Twelfth Embodiment

The twelfth embodiment is the same as the tenth embodiment except no message is sent to the remote caller. This embodiment allows a driver to safely remove the phone from his hear in order to attend driving tasks (requiring the hand which holds the cell phone) without interruption of the conversation. The conversation is not interrupted because the speakerphone is automatically turned ON when the phone is away from the driver's ear, and OFF when the cell phone is returned to the driver's ear. Driving tasks requiring the hand which also holds the cell phone may include steering with both hands, shifting or adjusting environmental controls. This feature may also be useful for any type of phone use including use other than operating a motor vehicle.

### CONCLUSION, RAMIFICATIONS, AND SCOPE

Thus, the reader will see that purposefully sending a message to a remote caller using the notification system can be used to quickly and easily reduce distraction to a driver who is dealing with an attentive condition. The invention works without the need for collecting and analyzing driving or vehicle information. The invention allows the driver to concentrate in times immediately after identifying an attentive condition when no immediate maneuver is required. The invention gives the driver uninterrupted time to concentrate on an attentive condition in the time before and during a maneuver. The invention does not create situations of false positives or positive feedback. It allows limited communication during activation and reduces reluctance a driver may have to abruptly interrupt a remote caller in mid-sentence.

Types of notification messages: Although the description above contains many specificities, these should not be construed as limiting the scope of the notification system, but merely provide illustrations of some of the presently preferred embodiments of the notification system. For example, the notification message's first audio can be comprised of ‘specific statements’, and alternately ‘implicit statements’ or ‘indicative sounds’ so long as the notification message has the conversation intensity reducing means to inform a remote caller to reduce her conversation intensity level. Specific statements may include “Attention, please pause”, “Please reduce the conversation intensity level”, “Please slow your speech”, “Please hold”, “Quiet please”, “Wait a second”, “Please wait a moment”, and “Please pause a moment”.

Implicit statements assume that the remote caller knows to reduce her conversation intensity level and the first audio of the notification message supplies additional information pertaining to the reason for the message. The implicit message may include “Encountering heavy traffic”, “Pulling into traffic”, “Driver is busy”, “Approaching an intersection”, “Passing”, “Encountering poor road conditions”, “Encountering limited visibility conditions”, “Braking”, “Turning”, “Attentive condition” and “Encountering an attentive condition”.

Indicative sounds assume that the remote caller knows to reduce her conversation intensity level. Indicative sounds are more typically used for the second audio of the notification message. Indicative sounds may include beeping, dinging, buzzing, clicking, music, real-time vehicle conditions, traffic noises, static noise, current road conditions, real-time sound of vehicle, and background noise. Many additional messages can be generated so long as they have the effect of informing and reminding a remote caller to maintain a reduced conversation intensity level.

Reduction levels of the notification message: The message can contain the means to request an amount that a remote caller should reduce her conversation intensity level to, including ‘high’, and alternately ‘medium’ and ‘low’ reduction levels. A high level reduction is then used for attentive conditions which must be quickly dealt with by a driver that involve danger, or a high degree of driver concentration. The remote caller is expected to immediately stop the current conversation to allow the driver to concentrate during the initial few seconds after activation. The remote caller may ask the driving status some time after the activation. High level reductions typically last less than 30 seconds. Examples of times when a high level reduction is useful include approaching an intersection, passing, changing lanes, pulling into traffic and approaching a road hazard.

Medium level reduction is useful for sustained attentive conditions which must be managed and involve a medium degree of driver concentration. During a medium level reduction, a remote caller is expected to maintain a slower and less intense conversation. Activation of a medium level reduction are typically sustained for greater than 30 seconds. Examples of medium level reductions include traveling in heavy traffic, during poor visibility conditions, poor road conditions, or traveling in an unfamiliar area. The notification message sent to a remote caller is preferably less obtrusive to the remote caller than that of a high level reduction because the remote caller may talk over the message and activation may last for a considerable amount of time. Preferably, the notification system allows a high level message to temporarily override a medium level message.

Low level reduction is useful for attentive conditions involving sustained low level attentive conditions such as operating a motor vehicle. During low level activation, a remote caller is expected to avoid conversations that are cognitively taxing and should be prepared for sudden interruptions. Low level activation can last for the duration of a call while the driver is operating a motor vehicle. The notification message sent to a remote caller is preferably a first audio at the start of the activation or the beginning of the phone call that informs the remote caller that she is having a conversation with a person operating a motorized vehicle. For example, the first audio may state “The person on this line is driving a motor vehicle, please maintain a reduced conversation level”. Preferably the first audio is followed by a second audio preferably consisting of a low frequency continual background noise or some other sound that has the means to continually remind the remote caller to maintain a reduced conversation intensity level. Preferably, medium and high level messages can temporarily override low level messages. Preferably, the device is able to silence the second audio sent to the remote caller when the driver is speaking. Preferably, the second audio allows communication to continue without annoying the remote caller.

Modulation of the notification message: Alternately, communication between the driver and remote caller can be modulated by the notification system. Modulated communication can be particularly useful for implementing medium and low level reductions in conversation intensity level. Modulated communication is done to reduce the conversation intensity level between the driver and remote caller by sending a second audio consisting of a periodic sound to the remote caller that encourages the remote caller to reduce or stop talking only while the periodic sound is playing and to resume talking between periodic sounds.

Preferably, the periodic sound is also played to the driver during activation so that the driver will reduce or stop talking during the same period during which the remote caller hears the message. Preferably voice transmission between telephones is suspended during only the period in which the periodic sound is being played.

Preferably, the duration and volume of the periodic sound can be altered in order to adjust the conversation to an appropriate level, based upon the driving difficulty. Preferably an input is provided by the notification system so that the driver can manually adjust the duration of the periodic sound. The input is preferably a finger operated slide mechanism located in close proximity to the activation switch.

Alternately, the length and duration of the periodic sound can be automatically adjusted by the notification system based upon sensor data that is generated internal and/or external to the vehicle. Internally generated sensor data can originate from the vehicle's speedometer and accelerometers located within the vehicle. Externally generated sensor data can originate from GPS signals and transmitted traffic reports. An additional alternate method of determining the periodic sound's length and duration can be achieved by a speech recognition module within the notification system that uses an algorithm to calculate a real-time conversation intensity level value and then adjusts the length or duration of the periodic sound until the conversation intensity level is reduced to an appropriate level.

Activation switch on the keypad: An alternate activation switch may be accessible through the keypad of a cell phone using a dedicated button or a button selection menu. Alternate users: Alternately, the notification system can also be useful for pedestrians to reduce distractions when encountering attentive conditions such as approaching and then walking across a street, or navigating through a parking lot. In these situations, a pedestrian can activate the notification system to improve safety while walking.

Current road conditions as the message: Alternately, the state of the vehicle or the current road conditions can comprise part or all of the first or second audios to provide a remote caller with accurate feedback about why the notification system was activated. In this case, preferably the driver is provided a single activation switch, which can then be purposefully activated during an attentive condition, and the notification system is able to then automatically determine the applicable notification message to send to the remote caller based upon road condition and sensor data. For example, the notification system can examine GPS data to determine if the automobile is approaching an intersection. If it determines that the vehicle is approaching an intersection and the vehicle is not decelerating, a first audio stating “approaching an intersection” is preferably played to the remote caller after the driver turns the activation switch ON. In another example, if the notification system senses that the vehicle is stopped, in-gear and its turn signal is ON, and the activation switch is turned ON then it will send a first audio to the remote caller stating “waiting to pull into traffic”.

Alternative message sending means: Alternatively, the notification system can be used to send a notification message to a remote caller other than through a cell phone audio output. For example, an additional signal could be sent to an additional communication device located at the location of the remote caller. The additional communication device may then convert the notification message into an audio, visual or vibration signal that is indicative of informing the remote caller that her conversation intensity level needs to be reduced.

Passenger notification: Alternately, the notification system's communication signal means can be used to generate a notification message to a passenger within the same motor vehicle as the driver. These messages may be audio or visual, so long as the message communicates to the passenger that the passenger should reduce her conversation intensity level, when the driver activates the notification system.

Alternate communication signal means: The notification system's communication signal means can alternately consist of other types of audio communication equipment including satellite phones, land lines, CB radios, and other portable telecommunication devices, so long as the communication signal means is able to send a notification message to inform a remote caller to reduce her conversation intensity level.

Distribution of the notification system: Integration of the control unit, activation switches, suppression switch and control unit of the notification system can include within a cell phone, speakerphone, headset, vehicle dashboard, vehicle entertainment center and remote telephone network. Distribution and sharing of he electronics within the control unit, activation switches, suppression switch can also be distributed and shared between a cell phone, headset, speakerphone, vehicle dashboard, vehicle entertainment system and a remote telephone network.

Microphone volume reduction: Alternately, the driver may wish to reduce his send voice during activation. This is preferably achieved by using a microphone suppression switch that is coupled to the control unit to reduce microphone volume when the notification system is activated and return the volume to normal when the notification system is deactivated.

Use of a GPS for activation: Alternately, the notification system may also read GPS transmitter data and compare the location of the vehicle to known areas of which the notification system should be activated. The driver may also define locations in which the notification system should be activated. Preferably locations can be defined when the driver presses and holds the activation switch for a predefined period of time.

Activation by other means: Alternately, the notification system may also be activated when either turn signal is activated, when the vehicle is placed in reverse, or when the driver's foot is placed over the brake pedal.

Total reduction of conversation intensity level: Alternately, the notification message may inform the remote caller to reduce her conversation intensity level to zero. This may be useful when the cell phone's speaker is completely suppressed.

Suppression of supplemental vehicle information: Alternately, the notification system may suppress nonessential information from being automatically presented to a driver when the notification system is activated. For example, the vehicle will not inform the driver that the vehicle is due for an oil change while the notification system is activated.

The activation switch may be comprised of a self contained module which communicates to the control unit using preferably radio frequency. If using radio frequency, preferably the mode of communication is Bluetooth. If encrypted radio frequency is transmitted by the activation switch, then the control unit has the means to decrypt the signal, in order to activate and send an applicable message to the remote caller. The switch module preferably is comprised of multiple switches. If multiple switches are used, then each switch can send a unique signal to the control unit. Preferably, the control unit sends the applicable notification message to the remote caller, based upon the selected switch.

Preferably, the remote control module is self powered and small enough to be mounted to a steering wheel. Preferably the mounting location is on the bottom face of the steering wheel. Preferably the switch is located on one of the steering wheel webs. Preferably, the location allows for easy access to the driver while the driver is still gripping the steering wheel with the same hand. Preferably, the switch module mounting is such that it can be easily removed. Preferably the switch is mounted using Velcro.

One alternate location for the switch includes from a bracket extending from the vehicle's turn signal lever.

Thus the scope of the invention should be determined by the appended claims and their legal equivalents, rather than by the examples given.

### REFERENCES

1. PUNITHA MANALAVAN, ASAD SAMAR, MIKE SCHNEIDER, SARA KIESLER, DAN SIEWIOREK, In-car cell phone use: mitigating risk by signaling remote callers, Proceedings of the SIGCHI conference on Human factors in computing systems, Apr. 20-25, 2002, Minneapolis, Minn., USA.
2. MIKE SCHNEIDER, SARA KIESLER, Calling while driving: effects of providing remote traffic context, Proceedings of the SIGCHI conference on Human factors in computing systems, Apr. 2-07, 2005, Portland, Oreg., USA.
3. CHIP WOOD, JOSHUA HURWITZ, Driver Workload Management During Cell Phone Conversations, Proceedings of the Third international Driving Symposium on Human Factors in Driver Assessment, Training and Vehicle Design, Motorola Labs.
4. E. E. SMITH, (1968). Choice reaction time: An analysis of major theoretical positions, Psychological Bulletin, 69, Pages 85-86.
5. PATRICIA TRBOVICH, JOANNE L. HARBLUK, Cell Phone Communication and Driver Visual Behavior: The Impact of Cognitive Distraction, Proceedings of the SIGCHI Conference on Human Factors In Computing Systems, Apr. 5-10, 2003, Ft. Lauderdale, Fla., USA.
6. D. L. STRAYER & W. A. JOHNSTON (2001). Driven to distraction: Dual-task studies of simulated driving and conversing on a cellular phone. Psychological Science, 12, 462-466.
7. “http://en.wikipedia.org/wiki/Executive_system”.
8. D. A. NORMAN, & T. SHALLICE, (1980) Attention to action: Willed and automatic control of behaviour. Reprinted in M. Gazzaniga (ed) (2000) Cognitive Neuroscience: A Reader. Blackwell. ISBN 063121660X.

1. A notification system comprising:
at least one of a plurality of activation switches, a control unit and at least one of a plurality of communication signal means;
each of said activation switches change from a first state to a second state when exposed to a first predefined voluntary actuation stimulus generated by a first person;
said control unit is coupled to each of said activation switches;
said control unit further comprises a first terminal;
a signal input of said communication signal means is coupled to said first terminal;
said control unit further comprises an activation switch detection means to detect the state of said activation switches;
said control unit further comprises a logic means to classify the state of said notification system as being activated or deactivated, based upon one of said activation switches being in its second state;
said control unit further comprises the message sending means to send a notification message to said first terminal when said notification system state has changed to activated;
said communication signal means comprises the signaling means to send said notification message to a second person;
said notification message comprises a conversation reducing means to inform a second person to reduce the conversation intensity level;
whereby when the notification system is put into an activated state by said first person then said notification message will be sent to said second person to reduce the conversation intensity level of said second person.

2. The notification system of claim 1 wherein said communication signal means further comprises
a cell phone operated by said first person and a remote telephone operated by said second person;
said signal input of said communication signal means is further comprised of audio input of said cell phone;
said cell phone and remote telephone are telephonically connected;
said communication signal to said second person is comprised of audio output of said remote telephone;
whereby when the notification system is put into an activated state by a first person who is using said cell phone then said notification message will be sent to said second person via the audio output of said remote telephone in order to reduce the conversation intensity level of said second person.

3. The notification system of claim 2 further comprises a speaker, and a suppression switch;
said control unit further comprises a second and third terminal;
said speaker is accessible to said first person and coupled to said third terminal;
said notification system further comprises a coupling between the audio output of said cell phone and said second terminal;
said control unit further comprises a coupling to said suppression switch;
said control unit further comprises a suppression switch detection means to detect the state of said suppression switch;
said control unit's logic means further comprises a means to classify the sub-state of said notification system as being suppressed or normal, based upon said suppression switch being in its second state when said system state is activated;
said control unit further comprises a volume reducing means to transmit an audio signal with reduced volume to said third terminal when the notification system's sub-state is suppressed, and
transmit an audio signal with the same volume to said third terminal when the notification system's sub-state is normal;
whereby said first person is able to selectively reduce the volume of said speaker when the notification system is in the activated state.

4. The notification system of claim 3 wherein said control unit further comprises a fourth terminal;
said forth terminal is coupled to said first terminal;
said notification system further comprises a microphone accessible to said first person and coupled to said forth terminal;
whereby said first person can talk to said second person while said notification system is in the activated state.

5. The notification system of claim 2 wherein said notification message is composed of at least one of a first and a second audio; said first and second audio are sent in sequential order.

6. The notification system of claim 5 wherein said first audio comprises said conversation reducing means, said audio is played a single time after said notification system is changed to its activated state;
whereby an initial announcement is played at the start of activation.

7. The notification system of claim 5 wherein said second audio comprises said conversation reducing means, said part is played until one of the said activation switches in its second state is changed to its first state;
whereby said second person is continually reminded to maintain a reduced conversation intensity level.

8. The notification system of claim 7 wherein said second audio is repeated at a predefined interval.

9. The notification system of claim 5 wherein a resume message comprises the conversation resumption means to inform said second person to resume normal conversation intensity level; said audio is played after said notification system is changed to the activated state;
whereby said second person is informed to resume a normal conversation intensity level.

10. The notification system of claim 2 wherein said notification message is composed of a first and second audio during the first instance in which said notification system changes to its activated state after said cell phone has been telephonically connected to said remote telephone;
for all subsequent changes of said notification system changes to its activated state, said notification message is composed of said second audio
whereby a full announcement is played once per telephone call.

11. The notification system of claim 12 wherein one of said activation switches comprises the ear detection means to detect if said cell phone is being held to the ear of the first person, and
said notification system further comprises the logic means to automatically change to its activated state when said cell phone is removed from the ear of the first person, and
said notification system further comprises the logic means to automatically change to its deactivated state when said cell phone is placed to the ear of the first person;
whereby said notification system is activated when said first person removes telephone from the ear of said first person.

12. the notification system of claim 1 further comprising the means to activate a speakerphone when the notification system is activated and deactivate a speakerphone when the notification system is deactivated.

13. The notification system of claim 1 wherein actuation stimuli of said activation switch is generated by a hand.

14. The notification system of claim 1 wherein actuation stimuli of said activation switch is generated by predefined sound generated by said first person;
whereby said notification system is voice activated.

15. The notification system of claim 1 wherein said activation switch is mounted on the steering wheel.

16. The notification system of claim 1 wherein said activation switch is mounted on the steering wheel column.

17. The notification system of claim 1 wherein said control unit comprises the means to send a notification system status message to said first person when said notification system is in the activated state;
said notification system status message comprises status informing means to inform said first person that said notification system is in its activated state;
whereby said first person is sent a reminder that the notification system is activated.

18. A method for reducing driver distraction, said method comprising the steps of:
establishing a wireless communication link between a driver and a remote caller;
selectively activating by said driver the transmission of at least one audible message for receipt by said remote caller, where in said at least one audible message comprises the means to inform said remote caller to reduce the conversation intensity level of said remote caller.

19. A notification system comprising:
a cell phone configured to establish a wireless communication link between a driver and a remote caller, said cell phone further configured, upon selective activation by said driver, to transmit at least one audible message for receipt by said remote caller,
wherein said at least one audible message comprises the means to inform said remote caller to reduce the conversation intensity level of said remote caller.
